(19) United States
(12) Patent Application Publication
(10) Pub. No.: US 2023/0414425 A1
(43) Pub. Date: Dec. 28, 2023

(54) DEVICE FOR SUPPORTING AND/OR STABILIZING AT LEAST ONE LIVING BEING

(71) Applicant: KOHLBRAT & BUNZ Gesellschaft m.b.H., Radstadt (AT)

(72) Inventor: Haakan RUGFELT, Falsterbo (SE)

(21) Appl. No.: 18/134,142

(22) Filed: Apr. 13, 2023

(30) Foreign Application Priority Data
Apr. 14, 2022 (AT) A 50246/2022

(51) Int. Cl. A61G 7/057; D04B 21/12

(52) U.S. Cl. CPC A61G 7/05738; A61G 7/05769; D04B 21/12

(57) ABSTRACT

A device for supporting and/or stabilizing at least one living being, in particular a person or an animal, comprising a base element having an evacuable and/or inflatable interior, and at least one support section arranged on or in the base element for supporting the living being. The support section has at least one compressive strength different from the base element, and the at least one support section has at least two textile fabrics. The at least two textile fabrics are joined to one another spaced apart from one another by a plurality of threads, and the base element and the at least one support section are joined to one another non-detachably.

The invention relates to a device for supporting and/or stabilizing at least one living being, in particular a person or an animal, comprising a base element, which has an evacuable and/or inflatable interior, and at least one support section arranged on or in the base element for supporting the living being, wherein the support section has at least one compressive strength different from the base element.

The support section serves primarily for relieving pressure on the at least one living being or for the prevention of bedsores.

Such devices are already known from the state of the art. For example, vacuum splint material, such as vacuum mattresses, is widely used in the rescue service. A living being is placed on the device, who thereby deforms it. By evacuating the interior this deformed form of the device can be fixed.

In order to design this support or stabilization to be as comfortable as possible for the living being, these devices are usually provided with a foam padding at least in areas. The splint material itself and the padding have different compressive strengths.

Inflatable pads with an additional foam padding are for example also known. The inflatable pad and the additional foam padding again have different compressive strengths.

The foam padding serves for additional pressure relief.

The compressive strength indicates how much pressure is necessary to impress a foam or a knitted or woven spacer fabric to a particular amount (for example 40%) of its original thickness/height.

A knitted or woven spacer fabric is made up of two textile fabrics, which are joined to one another by means of spacer threads.

A disadvantage of the state of the art is particularly the use of foam. The properties of foam deteriorate over its lifetime, for example it could harden. Moreover, a compressive strength of the foam changes under the influence of heat.

The purpose of an additional padding, namely the pressure relief, when using foam therefore can no longer or no longer sufficiently be fulfilled after a particular time.

The object of the invention is to specify a device for supporting and/or stabilizing at least one living being which is improved compared with the state of the art and which at least partly prevents the described disadvantages.

This object is achieved by the features of independent claim 1.

It is therefore provided that the at least one support section has at least two textile fabrics, wherein the at least two textile fabrics are joined to one another spaced apart from one another by means of a plurality of threads.

The textile fabrics joined to one another in this way have good cushioning properties and are therefore well suited to pressure relief. Moreover, the properties of such a construction do not change over its lifetime.

Moreover, a two-stage cushioning is thereby also realized, as the base body and the at least one support section have different compressive strengths and thus also different cushionings.

It is also provided that the base element and the at least one support section are joined to one another non-detachably. This allows the use of cost-effective and simple joining techniques.

Further advantageous embodiments of the invention are defined in the dependent claims.

It can particularly preferably be provided that the at least one support section is formed as a knitted spacer fabric or woven spacer fabric.

It can also be provided that the threads form a woven layer, preferably a pile layer, between the at least two textile fabrics.

This represents a simple way of joining the two textile fabrics via the threads.

It can be ensured through the corresponding density of threads that the combination of the textile fabrics and threads has the desired properties.

In particular, the number of threads influences the compressive strength of the knitted fabric. The number of threads must therefore be selected such that the knitted fabric has a compressive strength suitable for the application. If the number of threads is too small, a “tilting” of the layers can occur, i.e. the threads are not able to absorb the occurring load and maintain a distance between textile fabrics.

In an embodiment example it can be provided that the at least two textile fabrics and/or the threads are made from a plastic, preferably from polyester.

By using plastic, the required properties can again be achieved. Moreover, lifetime and resistance to environmental influences can be improved.

It can preferably be provided that the base element and the at least one support section are formed integral with one another.

It can thereby be ensured that the support section always sits in the correct place or places and thus guarantees a pressure relief in the necessary places.

According to a further embodiment example it can be provided that the at least one support section is formed fluidically isolated. An undesired penetration of contamination and the like is can thereby be prevented.

It can also be provided that the interior is inflatable and only filled with air. This represents a simple way of implementing the device.

It can alternatively or additionally be provided that the interior is evacuable and a granular material and/or an insertion body are/is arranged in the interior.

Via the granular material and/or the insertion body, the device can be given additional stability in the evacuated state.

Additionally, if the interior is also evacuable, then the interior can for example be divided into an inflatable and an evacuable area. However, it is also conceivable that the same areas of the interior are inflatable and evacuable.

It can be provided that the insertion body is formed in the style of a knitted spacer fabric or a woven spacer fabric.

The term “in the style of a knitted spacer fabric or a woven spacer fabric” is to be understood such that the insertion body is constructed according to the principle of a knitted spacer fabric or woven spacer fabric, but actually does not have the function of a knitted spacer fabric. This means that two textile fabrics would not necessarily always be held at a distance, such as would be the case for real knitted spacer fabrics or woven spacer fabrics. It is essential in this embodiment that the threads set the maximum distance between the two textile fabrics.

It can furthermore be provided that the at least one support section have/has a compressive strength of between 30 kPa and 60 kPa.

Through the corresponding combination of the compressive strengths an optimal pressure relief and thus the greatest possible wellbeing of a living being can be achieved.

It can be provided that the at least one support section has a thickness of between 2 mm and 40 mm.

The thickness of the support section again has an influence on the pressure relief and thus represents a further control variable, by means of which a pressure relief can be optimally set.

It is conceivable that the support section has a constant or, however, also a variable thickness.

It can preferably be provided that at least four textile fabrics are provided and wherein the at least four textile fabrics are in each case joined to one another in pairs by means of a plurality of threads.

It is also conceivable that at least three textile fabrics are provided and a first textile fabric is joined to a second textile fabric by means of a plurality of threads, and the second textile fabric is also joined to a third textile fabric by means of a plurality of threads.

It can preferably also be provided that the at least one support section comprises at least two plies of knitted spacer fabric or woven spacer fabric.

Particularly, if at least two of the at least two plies have different compressive strengths from one another, the at least two plies can fulfill different functions. For example, one ply can be formed mainly for cushioning and a second ply can be formed for even pressure distribution over the whole support section.

By way of example, at least one of the at least two plies can have a compressive strength of between 35 kPa and 60 kPa, preferably between 45 kPa and 55 kPa, particularly preferably 49 kPa, and/or at least one other of the at least two plies (L1, L2) can have a compressive strength of between 30 kPa and 55 kPa, preferably between 40 kPa and 50 kPa, particularly preferably 43 kPa.

According to a further embodiment example it can be provided that the at least one support section comprises at least three plies of knitted spacer fabric or woven spacer fabric.

Particularly if at least two of the at least three plies have a first compressive strength and at least one other of the at least three plies has a second compressive strength, the above-described division of functions can be adapted even more precisely to a corresponding intended use.

It can be provided that at least three plies are arranged such that a ply with a second compressive strength follows a ply with a first compressive strength and a ply with a first compressive strength follows a ply with a second compressive strength.

A support section can be better adapted to occurring loads, thus the weight of the at least one living being or the weight of a body part of the at least one living being to be supported, through the use of several layers with different compressive strengths.

Further details and advantages of the invention are explained in more detail below with the aid of the description of the figures with reference to the drawings. There are shown in:

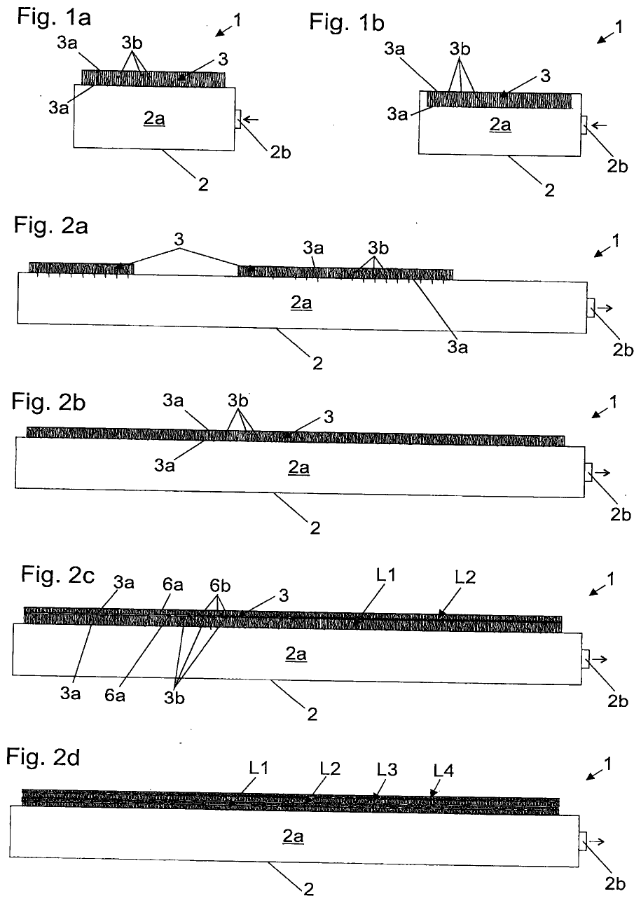

FIG. 1a a schematic sectional view of an embodiment example of a device, wherein the interior is inflatable,

FIG. 1b a schematic sectional view of a further embodiment example of a device, wherein the interior is inflatable,

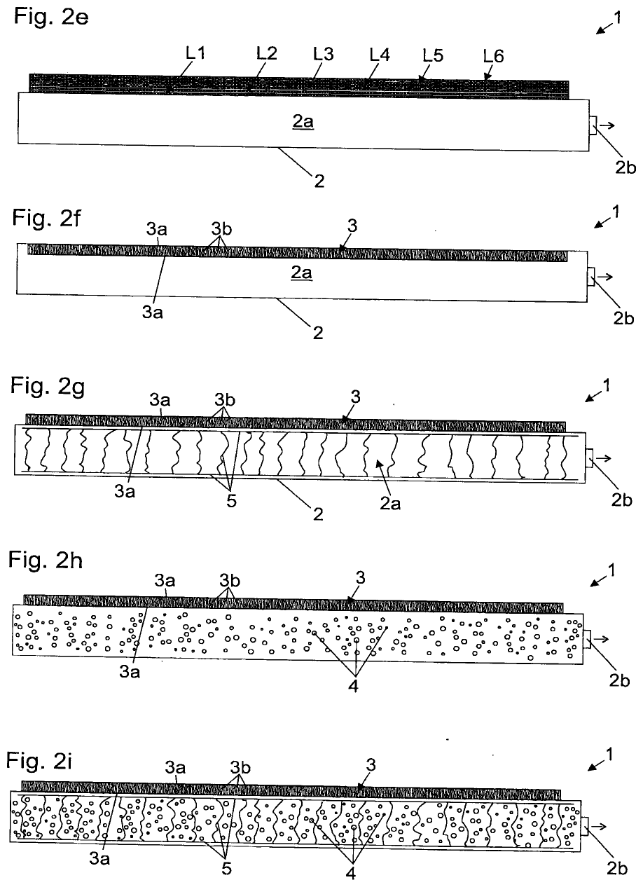

FIGS. 2a-i schematic sectional views of different embodiment examples of a device, wherein the interior is evaluable,

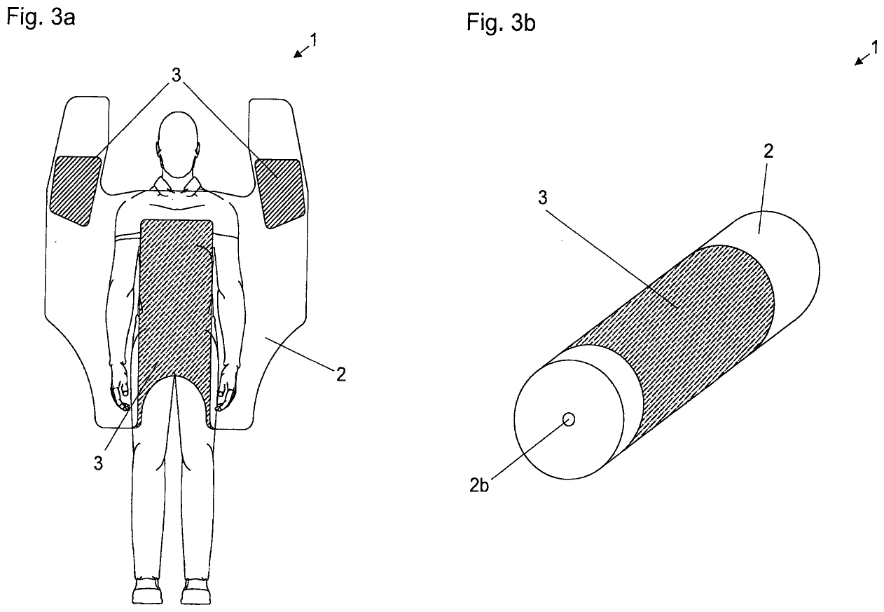

FIG. 3a a schematic top view of an embodiment example of a device with a person, and

FIG. 3b a schematic, perspective view of an embodiment of device.

FIG. 1a shows a schematic sectional view of an embodiment example of a device 1, wherein the interior 2a is inflatable and FIG. 1b a further embodiment example in an identical view. A base element 2 is visible, which has an inflatable interior 2a and an in-/outlet opening 2b. The arrow at the in-/outlet opening indicates that air is introduced into the interior 2a and the interior 2a or the base element 2 is inflated.

The base element 2 can for example consist of plastic and be formed like an air mattress. It is also conceivable that the interior 2a is subdivided into several chambers.

A support section 3 is arranged on the base element 2 in FIG. 1a. The support section 3 comprises two textile fabrics 3a and threads 3b which join the textile fabrics 3a to one another spaced apart from one another.

The support section 3 is substantially thus formed as a knitted or woven spacer fabric.

The embodiment example according to FIG. 1b differs to the effect that the support section 3 is now arranged in the base element 2. This thereby results in a flush surface of base element 2 and support section 3.

FIGS. 2a to 2i show schematic sectional views of different embodiment examples of a device 1, wherein the interior 2a is evaluable.

A base element 2 is again visible, which has an evacuable interior 2a and an in-/outlet opening 2b here. The arrow at the in-/outlet opening indicates that air is extracted by suction from the interior 2a and the interior 2a or the base element 2 is thus evacuated.

The devices shown in these figures could for example be a vacuum mattress.

In the embodiment example according to FIG. 2a a support section 3 is arranged on the base element 2 in areas; in the embodiment example according to FIG. 2b the support section 3 substantially extends over the entire length of the base element 2.

Four textile fabrics 3a, 6a are provided in the embodiment example according to FIG. 2c, wherein in each case the textile fabrics 3a are joined to one another spaced apart from one another via threads 3b and the textile fabrics 6a are joined to one another spaced apart from one another via threads 6b.

The textile fabrics 3a and the threads 3b substantially represent a first ply L1 of knitted or woven spacer fabric and the textile fabrics 6a and the threads 6b represent a second ply L2 of knitted or woven spacer fabric.

FIG. 2d shows an embodiment example with four plies L1, L2, L3, L4 of knitted or woven spacer fabric and FIG. 2e an embodiment example with six plies L1, L2, L3, L4, L5, L6 of knitted or woven spacer fabric.

In the embodiment examples with several plies of knitted spacer fabric, the plies can be of equal thickness/height or also of different thicknesses/heights.

The compressive strengths of the individual plies can also be the same or different.

In relation to both the thickness/height and the compressive strength of the plies, it can be provided that several plies are different or the same.

The arrangement of the plies can also vary. For example, plies with different properties can always be provided alternating or plies with the same properties in blocks.

FIG. 2f shows an embodiment example, in which the support area is again arranged in the base element 1.

In FIG. 2g an insertion body 5, which gives the device 1 additional structure and stability in an evacuated state, is arranged in the interior 2a of the base element 1.

In FIG. 2f granular material 4, which substantially serves the same purpose as the insertion body 5 in FIG. 2g, is arranged in the interior 2a.

In the embodiment example according to FIG. 2i both insertion body 5 and granular material 4 are provided. Besides the additional stability, the granular material 4 can also be kept evenly distributed in the interior 2a by the insertion body 5.

The embodiments according to FIGS. 1a, 1b and 2a to 2i can in principle be combined with one another as desired, for example an inflatable base element 2 with a multi-ply support section 3, an evacuable base element 2 with granular material 4 in the interior 2a and a support section 3 arranged in the interior 2a etc.

FIG. 3a shows a schematic top view of a device 1 and FIG. 3b a schematic top view of a device with a person.

FIG. 3a shows a schematic top view of an embodiment example of a device 1 with a person. In this embodiment example the base element 2 is formed as an evacuable mattress. The specific shape of the base element 2 makes it possible to optimally secure a person.

In this embodiment example of the invention the part of the support section 3 in the shoulder area serves for preventing pressure peaks on the person in said area.

The part of the support section 3 under the upper body/buttocks of the person provides for an even pressure distribution.

To this end, the base element 2 is laid on the sides around the person, so that the person is laterally supported. The two upper parts of the support section 3 then rest against the shoulders of the person and secure them.

The different areas of the support section 3 can be formed different or the same, i.e. they can have for example different or the same compressive strengths, a different or the same number of plies etc.

FIG. 3b shows a schematic, perspective view of an embodiment of a device 1. The base element 2 is made as a substantially cylindrical, inflatable pad.

The base element 2 can be inflated via an in-/outlet opening 2b. The support section 3 is arranged on the base element 2. This can be formed continuous, thus along the entire periphery of the base element 3, or only cover a particular area of the base element 3.

List of reference numbers:
1 device
2 base element
2a interior
2b in-/outlet opening
3 support section
3a textile fabrics
3b threads
4 granular material
5 insertion body
6a textile fabrics
6b threads
L1 first ply
L2 second ply
L3 third ply
L4 fourth ply
L5 fifth ply
L6 sixth ply

1. A device for supporting and/or stabilizing at least one living being, in particular a person or an animal, comprising a base element, which has an evacuable and/or inflatable interior, and at least one support section arranged on or in the base element for supporting the living being, wherein the support section has at least one compressive strength different from the base element, wherein the at least one support section has at least two textile fabrics, wherein the at least two textile fabrics are joined to one another spaced apart from one another by means of a plurality of threads, wherein the base element and the at least one support section are joined to one another non-detachably.

2. The device according to claim 1, wherein the at least one support section is formed as a knitted spacer fabric or woven spacer fabric.

3. The device according to claim 1, wherein the threads form a woven layer, preferably a pile layer, between the at least two textile fabrics

4. The device according to claim 1, wherein the at least two textile fabrics and/or the threads are made from a plastic, preferably from polyester.

5. The device according to claim 1, wherein the base element and the at least one support section are formed integral with one another.

6. The device according to claim 1, wherein the at least one support section is formed fluidically isolated.

7. The device according to claim 1, wherein the interior is inflatable and only filled with air.

8. The device according to one of claim 1, wherein the interior is evacuable and a granular material and/or an insertion body are/is arranged in the interior.

9. The device according to claim 8, wherein the insertion body is formed in the style of a knitted spacer fabric or a woven spacer fabric.

10. The device according to claim 1, wherein the at least one support section have/has a compressive strength of between 30 kPa and 60 kPa.

11. The device according to claim 1, wherein the at least one support section has a thickness of between 2 mm and 40 mm.

12. The device according to claim 1, wherein at least four textile fabrics are provided and wherein the at least four textile fabrics are in each case joined to one another in pairs by means of a plurality of threads.

13. The device according to one of claim 1, wherein the at least one support section comprises at least two plies of knitted spacer fabric or woven spacer fabric.

14. The device according to claim 13, wherein at least two of the at least two plies have different compressive strengths from one another.

15. The device according to claim 14, wherein at least one of the at least two plies has a compressive strength of between 35 kPa and 60 kPa, preferably between 45 kPa and 55 kPa, particularly preferably 49 kPa, and/or wherein at least one other of the at least two plies has a compressive strength of between 30 kPa and 55 kPa, preferably between 40 kPa and 50 kPa, particularly preferably 43 kPa.

16. The device according to claim 1, wherein the at least one support section comprises at least three plies of knitted spacer fabric or woven spacer fabric.

17. The device according to claim 16, wherein at least two of the at least three plies have a first compressive strength and at least one other of the at least three plies has a second compressive strength.

18. The device according to claim 17, wherein the at least three plies are arranged such that a ply with a second compressive strength follows a ply with a first compressive strength and a ply with a first compressive strength follows a ply with a second compressive strength.
